(19) United States
(12) Patent Application Publication
(10) Pub. No.: US 2026/0268444 A1
(43) Pub. Date: Sep. 10, 2026

(54) DISPLAY SYSTEM, IMAGE PROCESSING DEVICE, CORRECTION DATA GENERATION METHOD

(71) Applicant: ALPS ALPINE CO., LTD., Tokyo (JP)

(72) Inventor: Jin TAKEYAMA, Fukushima (JP)

(21) Appl. No.: 19/409,200

(22) Filed: Dec. 4, 2025

(30) Foreign Application Priority Data
Jan. 16, 2025 (JP) 2025-006273

(51) Int. Cl. G06T 5/20

(52) U.S. Cl. CPC G06T 5/20; G06T 2207/10024

(57) ABSTRACT

A display system includes a patterned cover part having a large number of micropores; a display device including a display part covered by the patterned cover part; and an image processing device configured to process image data to be displayed on the display device. The image processing device includes a memory configured to store correction data generated by performing gradation inversion on data of a luminance distribution that appears on the patterned cover part when an entirety of the display part of the display device is uniformly displayed in a single color, and by subjecting the inverted data to processing by a low-pass filter, and a processor coupled to the memory and configured to correct the image data to be displayed on the display part, based on the correction data read out from the memory.

### CROSS-REFERENCE TO RELATED APPLICATIONS

This application is based on and claims priority to Japanese Patent Application No. 2025-006273, filed on Jan. 16, 2025, the entire contents of which are incorporated herein by reference.

### BACKGROUND OF THE INVENTION

### 1. Field of the Invention

The present disclosure relates to a display system, an image processing device, and a correction data generation method.

### 2. Description of the Related Art

A technology by which necessary visual information is provided by a display during use and the display appears absent during nonuse is known (for example, see Japanese Laid-Open Patent Publication No. 2001-331132). An in-vehicle display device described in Japanese Laid-Open Patent Publication No. 2001-331132 is fitted into a wood-grain panel of an instrument panel of a vehicle, and the front surface of a display, which emits display light to the outside when the display is turned on, is covered by a wood-grain screen having a large number of micropores through which the display light can be transmitted. Thus, while the screen is visible through the micropores of the screen when the display is turned on, the display is hidden by the wood-grain screen when the display is turned off. Therefore, the entire instrument panel, including the part having the display fitted therein, has a unified wood-grain pattern.

### SUMMARY OF THE INVENTION

According to an embodiment of the present disclosure, a display system includes a patterned cover part having a large number of micropores; a display device including a display part covered by the patterned cover part; and an image processing device configured to process image data to be displayed on the display device. The image processing device includes a memory configured to store correction data generated by performing gradation inversion on data of a luminance distribution that appears on the patterned cover part when an entirety of the display part of the display device is uniformly displayed in a single color, and by subjecting the inverted data to processing by a low-pass filter, and a processor coupled to the memory and configured to correct the image data to be displayed on the display part, based on the correction data read out from the memory.

### BRIEF DESCRIPTION OF THE DRAWINGS

FIG. 1 is a drawing schematically illustrating an example configuration of a display system according to an embodiment;

FIGS. 2A and 2B are front views each illustrating a state in which an instrument panel is viewed from the front;

FIG. 3 is a block diagram illustrating an example functional configuration of an image processing device according to the embodiment;

FIGS. 4A to 4E are drawings illustrating a correction data generation method according to the embodiment;

FIGS. 5A to 5D are drawings illustrating an example of a correction process by an image processor according to the embodiment;

FIG. 6 is a drawing illustrating a cutoff frequency of a low-pass filter; and

FIGS. 7A and 7B are drawings illustrating parallax when a display part is viewed obliquely.

### DESCRIPTION OF THE EMBODIMENTS

A technology by which an image is displayed on a display only when necessary is referred to as Shytech. In recent years, Shytech has attracted attention as a technology for displaying a screen on an interior part having a pattern such as a wood-grain pattern or a fabric pattern. However, because the interior part in which Shytech is implemented is not a display space optimized for screen display, there is a problem in which an image displayed on the screen and the pattern of the interior part overlap each other, thereby making it difficult to see the displayed image.

In view of the above, it is desirable to reduce a problem in which, in a display system in which a display part is covered by a patterned cover part having a large number of micropores, a display image on the display part seen through the micropores overlaps the pattern of the cover part, thereby making it difficult to see the display image.

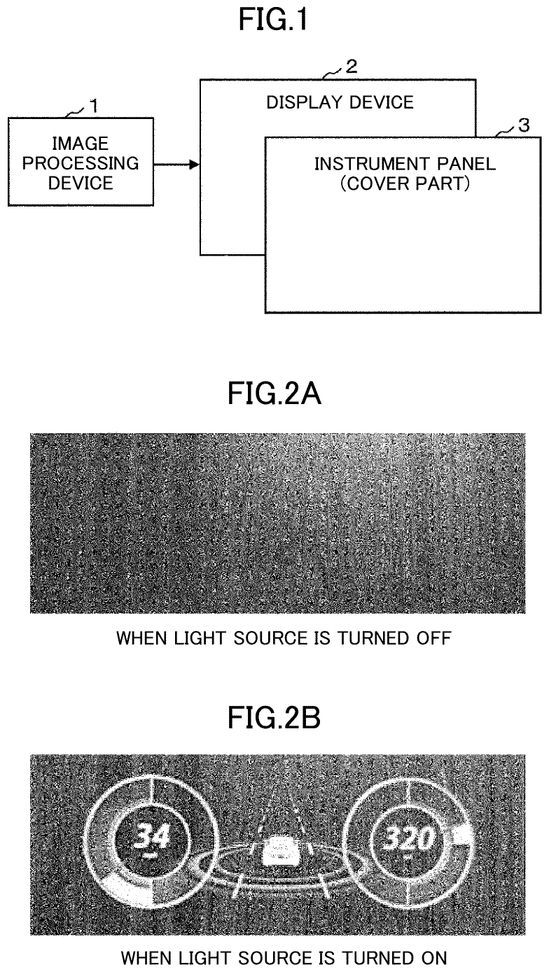

In the following, embodiments of the present disclosure will be described with reference to the drawings. FIG. 1 is a drawing schematically illustrating an example configuration of a display system according to an embodiment. In the present embodiment, as an example, a configuration in which the display system is applied inside a vehicle is illustrated. As illustrated in FIG. 1, the display system according to the present embodiment includes an image processing device 1, a display device 2, and an instrument panel 3.

The image processing device 1 is a device configured to process image data to be displayed on a display part of the display device 2, and supply the generated image data to the display device 2. For example, the image processing device 1 receives image data generated by an in-vehicle device (not illustrated), corrects the received image data based on correction data, and supplies the corrected image data to the display device 2. Alternatively, the image processing device 1 may store an application program for image generation, correct, based on correction data, image data generated by executing the application program, and supply the corrected image data to the display device 2.

The display device 2 is, for example, a liquid crystal display, an organic electroluminescent display, or an LED display. The display device 2 includes a light source, a driver, and the display part. The display device 2 receives image data from the image processing device 1, and displays an image on the display part by controlling the light source and the driver based on the image data. The display part includes a display panel.

The instrument panel 3 corresponds to a cover part described in the claims. The display device 2 is installed on the back side of the instrument panel 3 (inside a dashboard or a console in which the instrument panel 3 is installed), and the front surface of the display part of the display device 2 is covered by the instrument panel 3. The size of the display part of the display device 2 and the size of the instrument panel 3 are not necessarily the same, as long as the entire display part is covered by the instrument panel 3.

The instrument panel 3 has an arbitrary pattern such as a wood-grain pattern or a fabric pattern. Further, the instrument panel 3 has a large number of micropores through which display light output through the display part can be transmitted. When the light source of the display device 2 is turned on, display light from the display part is transmitted forward through the micropores of the instrument panel 3, and as a result, a display image can be seen through the instrument panel 3. Conversely, when the light source is turned off, no image can be seen on the instrument panel 3, and the entire instrument panel 3 has a unified pattern such as a wood-grain pattern.

FIGS. 2A and 2B are front views each illustrating a state in which the instrument panel 3 is viewed from the front. FIG. 2A illustrates a state in which the light source is turned off, and FIG. 2B illustrates a state in which the light source is turned on. Note that FIG. 2B illustrates a state in which an image obtained based on uncorrected image data is displayed.

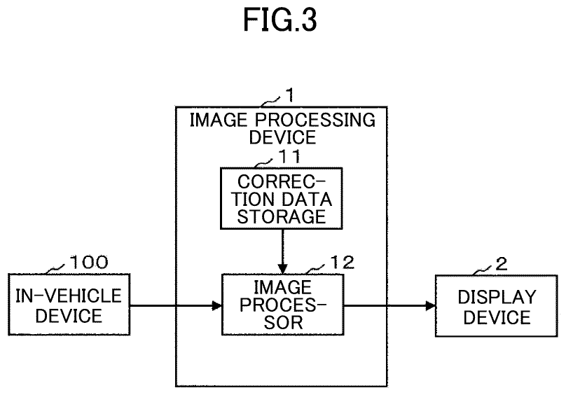

FIG. 3 is a block diagram illustrating an example functional configuration of the image processing device 1. As illustrated in FIG. 3, the image processing device 1 according to the present embodiment includes a correction data storage 11 and an image processor 12. The image processor 12 executes a process as described below in cooperation with hardware and software. For example, the process of the image processor 12 is executed by a program stored in a storage medium such as a RAM, a ROM, a hard disk, or a semiconductor memory, as controlled by a microcomputer that includes a CPU, a RAM, a ROM, and the like. In addition to the microcomputer, the image processor 12 may include a digital signal processor (DSP), a graphics processing unit (GPU), and the like.

The correction data storage 11 stores correction data generated in advance, for example, when the display system is manufactured or mounted in a vehicle. The correction data is generated by performing gradation inversion on data of a luminance distribution, appearing on the instrument panel 3 when the entire display part is uniformly displayed in a single color under a condition that the ambient illuminance of the instrument panel 3 is controlled to a predetermined state, and by subjecting the inverted data to low-pass filter processing.

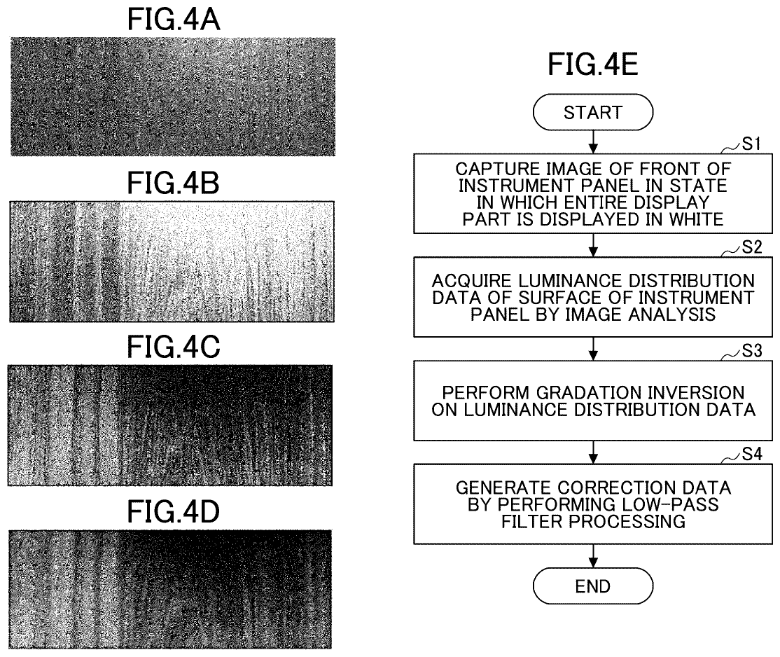

FIGS. 4A to 4E are drawings illustrating a correction data generation method. For example, correction data is generated by an image analysis device (not illustrated). FIG. 4A is a front view illustrating a state in which the instrument panel 3 is viewed from the front, and illustrates a state when the light source of the display device 2 is turned off. As described above, when the light source of the display device 2 is turned off, no display image is seen on the instrument panel 3, and the entire instrument panel 3 has a unified pattern such as a wood-grain pattern.

First, under a condition that the ambient illuminance of the instrument panel 3 illustrated in FIG. 4A is controlled to a predetermined state, an image of the instrument panel 3 is captured from the front of the instrument panel 3 in a state in which the entire display part of the display device 2 is uniformly displayed in white (step S1). The condition that the ambient illuminance of the instrument panel 3 is controlled to the predetermined state refers to, for example, a condition that the surface of the instrument panel 3 is uniformly irradiated with external light at a predetermined illuminance in a dark room.

Under a condition that the ambient illuminance is controlled as described above, the display device 2 displays a solid white image (hereinafter referred to as a white image) on the entire surface of the display part. Accordingly, display light of the white image is transmitted forward through the micropores of the instrument panel 3, and as a result, the white image and the pattern of the instrument panel 3 appear to overlap each other when viewed from the front of the instrument panel 3. An image of the instrument panel 3 in this state is captured by a camera from the front.

Next, the image analysis device acquires luminance distribution data of the surface of the instrument panel 3 by analyzing data of the captured image of the instrument panel 3 (step S2). FIG. 4B illustrates the luminance distribution data acquired in this manner, that is, the luminance distribution data of the surface of the instrument panel 3 acquired when the white image is displayed on the entire display part under the condition that the ambient illuminance of the instrument panel 3 is controlled to the predetermined state. The luminance distribution data acquired in step S2 is luminance distribution data of a region, of the entire surface of the instrument panel 3, facing the entire surface of the display part.

Next, the image analysis device performs gradation inversion on the luminance distribution data of the instrument panel 3 (step S3). FIG. 4C illustrates gradation inversion data generated by performing gradation inversion (negative-positive inversion) on the luminance distribution data of FIG. 4B. The luminance distribution data on which the gradation inversion is performed is image data obtained by performing gradation inversion on the entirety of the luminance distribution of the pattern of a portion of the instrument panel 3 facing the display part.

Further, the image analysis device generates correction data by subjecting the luminance distribution data, on which the gradation inversion is performed, to processing by a low-pass filter (step S4). FIG. 4D illustrates correction data ultimately generated by subjecting the luminance distribution data to the processing by the low-pass filter. Details of the processing by the low-pass filter will be described later.

In the present embodiment, the correction data generated as described above is stored in the correction data storage 11. Because a pattern of an instrument panel 3 differs for each vehicle in which the instrument panel 3 is mounted, correction data reflecting the pattern of the instrument panel 3 is generated for a corresponding display system mounted in the vehicle and stored in a corresponding correction data storage 11 of the vehicle. Note that generation of correction data as described above may be performed by the image processing device 1.

Referring back to FIG. 3, the description continues. The image processor 12 corrects image data to be displayed on the display part of the display device 2 based on correction data read out from the correction data storage 11. In the example of FIG. 3, the image processor 12 corrects original image data, input from an in-vehicle device 100, based on correction data stored in the correction data storage 11, and supplies the corrected original image data (hereinafter referred to as corrected image data) to the display device 2. For example, the image processor 12 performs, as a correction process, a process of superimposing the correction data on the original image data.

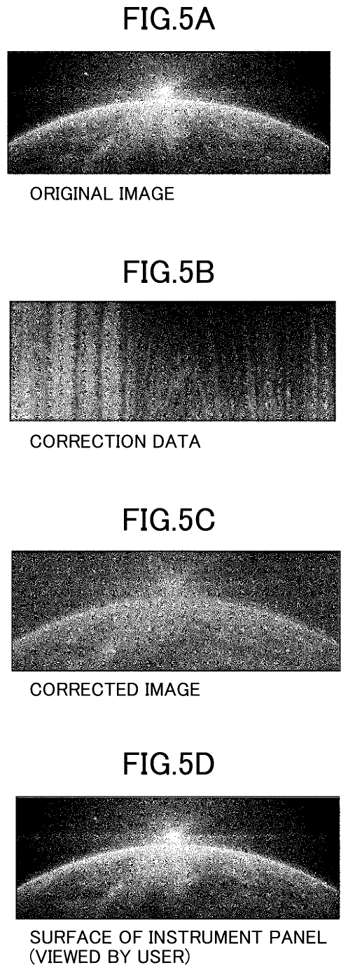

FIGS. 5A to 5D are drawings illustrating an example of a correction process by the image processor 12. FIG. 5A illustrates original image data input into the image processor 12. FIG. 5B illustrates correction data stored in the correction data storage 11. The image processor 12 performs a process of superimposing the correction data of FIG. 5B on the original image data of FIG. 5A. FIG. 5C illustrates corrected image data generated by the correction process. FIG. 5D illustrates a state in which the instrument panel 3 is viewed from the front when a corrected image obtained based on the corrected image data is displayed on the display part of the display device 2.

The corrected image data illustrated in FIG. 5C is image data in which correction equivalent to canceling the pattern of the instrument panel 3 is performed on the original image data of FIG. 5A. Therefore, when the corrected image obtained based on the corrected image data is displayed on the display part, the pattern of the instrument panel 3 is not easily seen because of components of the correction data included in the corrected image seen through the micropores of the instrument panel 3. As a result, the original image becomes easy to see without being obstructed by the pattern of the instrument panel 3 as illustrated in FIG. 5D.

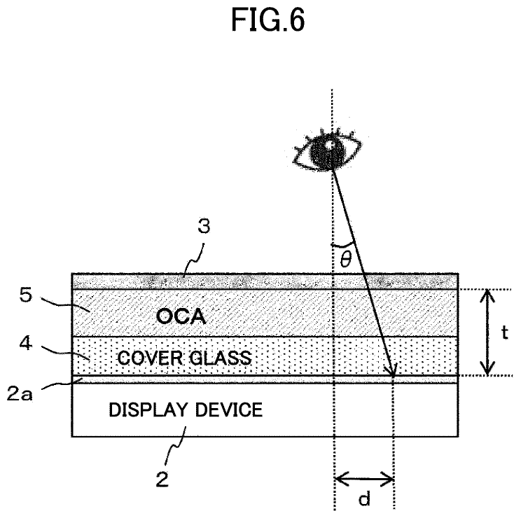

The low-pass filter will be described in detail. In the present embodiment, for example, a spatial frequency corresponding to a maximum parallax amount on the display part, determined from a viewing angle with respect to a direction normal to the display part and the thickness of a gap between the cover part and the display part, is set as a cutoff frequency of the low-pass filter. FIG. 6 is a drawing illustrating the cutoff frequency of the low-pass filter.

As illustrated in FIG. 6, a cover glass 4 and an optically clear adhesive (OCA) film 5 are sandwiched between a display part 2a of the display device 2 and the instrument panel 3, and a gap is present between the instrument panel 3 and the display part 2a. The thickness of the gap is represented by t [mm]. In addition, the viewing angle with respect to the direction normal to the display part 2a is represented by θ. The viewing angle θ is an angle representing a maximum range in which an image displayed on the display part 2a correctly appears when viewed obliquely, and is a value obtained according to specifications of the display device 2.

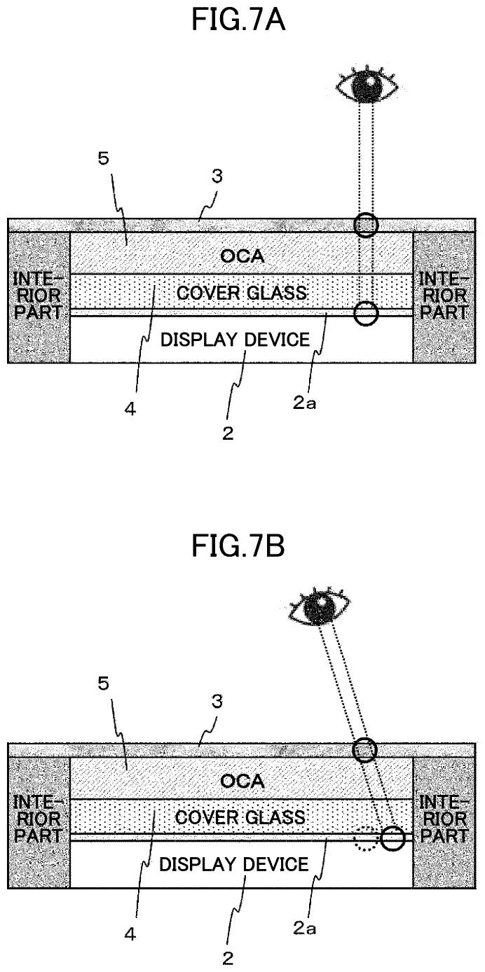

As illustrated in FIG. 7A, when a user views the display part 2a from the front in the direction normal to the display part 2a, the position of the pattern of the instrument panel 3 appears to coincide with the position of an image of a gradation-inverted pattern displayed on the display part 2a, which is obtained based on correction data superimposed on original image data. Therefore, the pattern of the instrument panel 3 appears to be canceled by the image of the gradation-inverted pattern obtained based on the correction data. Conversely, as illustrated in FIG. 7B, when the user views the display part 2a obliquely in a direction deviated from the normal to the display part 2a, the position of the pattern of the instrument panel 3 and the image of the pattern displayed on the display part 2a, which is obtained based on the correction data, appears to deviate from each other, that is, parallax occurs.

FIG. 6 illustrates a maximum disparity amount d that occurs when the display part 2a is viewed obliquely from a position at the viewing angle θ. This maximum parallax amount d is expressed by d=t·tan θ [mm]. Assuming that the cutoff frequency of the low-pass filter is defined by the number of dots [px] on the display part 2a and that the size of one dot is s [mm/px], the cutoff frequency cf is expressed by:

$$cf [ px ] = d [ mm ] / s [ mm / px ]$$

When the cutoff frequency is set as described above, in an image of a gradation-inverted pattern obtained based on correction data generated by performing low-pass filter processing, components of the pattern, which are finer than the maximum parallax amount d determined according to the viewing angle θ, are removed and the contours of the pattern are gently rounded. Therefore, when the display part 2a is viewed obliquely through the instrument panel 3, a problem in which the image of the pattern obtained based on the correction data appears deviated from the pattern of the instrument panel 3, thereby making it difficult to see a display image, can be reduced.

As described in detail above, in the present embodiment, correction data is generated by performing gradation inversion on data of a luminance distribution that appears on the instrument panel 3 when a white image is displayed on the entire display part 2a of the display device 2, and by subjecting the inverted data to low-pass filter processing, and image data to be displayed on the display part 2a is corrected based on the correction data.

According to the present embodiment configured in this manner, it is possible to obtain an effect equivalent to canceling the pattern of the instrument panel 3 by using an image of a gradation-inverted pattern obtained based on correction data. In addition, it is possible to obtain an effect equivalent to gently rounding the contours of the gradation-inverted pattern in the image by performing low-pass filter processing. Therefore, when the display part 2a is viewed from the front or viewed obliquely through the instrument panel 3, a problem in which a display image on the display part 2a seen through the micropores of the instrument panel 3 overlaps with the pattern of the instrument panel 3, thereby making it difficult to see the display image, can be reduced. Accordingly, the quality of the display image can be improved.

In the above-described embodiment, an example in which an image of a single color uniformly displayed on the entire display part 2a is a white image has been described; however, the display color is not limited to white. For example, the display color may be gray or may be the same color as the color of the instrument panel 3.

Further, in the above-described embodiment, an example in which the display system is applied inside a vehicle has been described; however, the present invention is not limited thereto. For example, the present invention is not limited to the display system in which the display device 2 is built and fixed inside a dashboard or the like, and may be applied to a portable display system in which the image processing device 1, the display device 2, and the cover part are configured to be portable.

Further, in the above-described embodiment, an example in which a cut-off frequency determined based on the viewing angle θ is set has been described; however, the present invention is not limited thereto. For example, a cutoff frequency determined based on an angle larger than the viewing angle θ may be set in the low-pass filter. Conversely, a cutoff frequency determined based on an angle smaller than the viewing angle θ may be set in the low-pass filter. In the latter case, a range in which fine pattern components of an image, obtained based on correction data, are rounded by low-pass filter processing is narrowed. Thus, deterioration of the quality of a display image when the display part 2a is viewed from the front or viewed at an angle close to the front can be suppressed. In the display system to which the present embodiment is applied, the cutoff frequency of the low-pass filter can be appropriately set in accordance with circumstances such as a range from which the user often views the display part 2a.

Further, embodiments described above are non-limiting examples merely examples of implementing the present disclosure, and the technical scope of the present disclosure should not be construed as being limited by these examples. That is, the present disclosure can be implemented in various forms without departing from its gist or its main features.

According to the present disclosure configured as described above, image data to be displayed on a display part is subjected to correction equivalent to canceling a pattern of a cover part. As a result, a problem in which the display image on the display part seen through micropores overlaps the pattern of the cover part, thereby making it difficult to see the display image, can be reduced, and thus, the quality of the display image can be improved. In addition, because the contours of a gradation-inverted pattern in the image obtained based on correction data are gently rounded by low-pass filter processing, a problem in which the gradation-inverted pattern appears to be deviated from the pattern of the cover part when the display part is viewed obliquely through the cover part, thereby making it difficult to see the display image, can be reduced.

What is claimed is:

1. A display system comprising:
a patterned cover part having a large number of micropores;
a display device including a display part covered by the patterned cover part; and
an image processing device configured to process image data to be displayed on the display device, wherein
the image processing device includes
a memory configured to store correction data generated by performing gradation inversion on data of a luminance distribution that appears on the patterned cover part when an entirety of the display part of the display device is uniformly displayed in a single color, and by subjecting the inverted data to processing by a low-pass filter, and
a processor coupled to the memory and configured to correct the image data to be displayed on the display part, based on the correction data read out from the memory.

2. The display system according to claim 1, wherein a spatial frequency equivalent to a maximum parallax amount on the display part is set as a cutoff frequency of the low-pass filter, the maximum parallax amount being determined from a viewing angle with respect to a direction normal to the display part and a thickness of a gap between the cover part and the display part.

3. An image processing device comprising:
a memory configured to store correction data generated by performing gradation inversion on data of a luminance distribution that appears on a patterned cover part having a large number of micropores when an entirety of a display part of a display device, covered by the patterned cover part, is uniformly displayed in a single color, and by subjecting the inverted data to low-pass filter processing; and
a processor coupled to the memory and configured to correct image data to be displayed on the display part, based on the correction data read out from the memory.

4. A correction data generation method comprising:
capturing an image of a patterned cover part having a large number of micropores from a front of the cover part in a state in which an entirety of a display part of the display device, covered by the patterned cover part, is uniformly displayed in a single color;
acquiring luminance distribution data from data of the captured image of the patterned cover part;
performing gradation inversion on the luminance distribution data; and
generating correction data by subjecting the luminance distribution data on which the gradation inversion is performed to low-pass filter processing.
